(19) United States
(12) Patent Application Publication
(10) Pub. No.: US 2007/0289009 A1
(43) Pub. Date: Dec. 13, 2007

(54) Authentication in a multiple-access environment

(75) Inventor: Son Phan-Anh, Budapest (HU)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/806,426

(22) Filed: May 31, 2007

Related U.S. Application Data
(60) Provisional application No. 60/812,593, filed on Jun. 12, 2006.

(51) Int. Cl. G06F 15/16

(52) U.S. Cl. 726/12

(57) ABSTRACT

Authentication of a user of a communication system includes a proxy server interfacing with a plurality of access networks, a session control server and an authentication server. Authentication includes detecting, at the proxy server, an access network from the plurality of access networks, to which a user to be authenticated is attached; determining, at the proxy server, a security-related attribute of the detected access network, and notifying the determined security-related attribute from the proxy server to the session control server.

### CROSS REFERENCE TO RELATED APPLICATION

This application claims priority of U.S. Provisional Patent Application Ser. No. 60/812,593, filed on Jun. 12, 2006, the entire contents of which are incorporated herein by reference.

### FIELD OF THE INVENTION

The present invention relates to authentication in a multiple-access environment. In particular, the present invention relates to authentication of a user of a communication system comprising a proxy server interfacing with a plurality of access networks, a session control server and an authentication server, wherein said communication system may support at least two separate authentication schemes, such as for example IMS-AKA, Early IMS Security, NASS-bundled Authentication, and/or HTTP Digest.

### BACKGROUND OF THE INVENTION

In recent years, communication technology has widely spread in terms of number of users and amount of use of the telecommunication services by the users. This also led to an increase in the number of different technologies and technological concepts in use.

Accordingly, there is a need for convergence of networks and systems based on such different technologies and technological concepts into overall network systems. Examples for such different technologies may include GPRS (General Packet Radio Service) or CDMA (Code Divisional Multiple Access) or, in general, IP-based (IP: Internet Protocol) networks. Further, there is a need for convergence of different services, functions and applications into overall network systems. Such converged network systems are often referred to as next generation networks. Examples for such next generation networks include networks specified by 3GPP (Third Generation Partnership Project) or IETF (Internet Engineering Task Force) or TISPAN (Telecom and Internet Converged services and Protocols for Advanced Networks).

That leads to the situation that some common subsystems such as the IP Multimedia Subsystem (IMS) working in such converged environment need to serve several types of user equipment (UE) attaching to several types of access networks. Even more complicated, some authentication mechanisms are either bound to a specific access environment or bound to a certain access technology.

For ensuring security and trustiness within such overall communication systems, which is particularly important for functions and services related to security-relevant, personal and/or confidential data, and for controlling access to such network systems and parts thereof, an user authentication is usually performed. However, as mentioned above, those authentication schemes work in different fashions and selecting the correct authentication scheme to be applied is not feasible. Stated in more general terms, there arise problems based on heterogeneous operation processes within an overall communication system.

In general, different authentication schemes may be required depending on a type of access network or on a different capability of the user equipment used by a user to be authenticated. For example, the applicability of an authentication scheme may depend on the provisioning of that scheme to a corresponding identity, the ability of a user equipment to handle that scheme, and/or the scheme specifically requested by a user equipment, if any.

For example, an IP Multimedia Subsystem (IMS) is conceivable as a present example of an above-mentioned communication system. In FIG. 1 of the accompanying drawings, a basic overview of an exemplary IMS architecture is illustrated, however only depicting those network elements which are relevant for the subsequent description.

A terminal denoted by UE (for user equipment) is able to access the IMS network via an access network, four of which are shown as an example, and a proxy call session control function P-CSCF, i.e. a proxy server. A proxy server may interface with a single access network or with a plurality of access networks. All or some P-CSCFs of the IMS network are interconnected via an interrogating call session control function I-CSCF. Further, the P-CSCFs each are connected to a serving call session control function S-CSCF, i.e. a session control server, which is also connected to the I-CSCF. The S-CSCF and the I-CSCF both are connected to a home subscriber server HSS and/or user profile storage function UPSF. The interface between a call session control function CSCF and a home subscriber server HSS and/or user profile storage function UPSF is usually referred to as Cx interface, as indicated in FIG. 1.

According to current specifications, signaling concerning registration and session control in an IMS network is based on a well-known session initiation protocol (SIP)

An access network according to FIG. 1 may for example include a GPRS based network, a 3GPP based network, or a TISPAN based network, including various technologies such as for example WLAN (wireless local area network) or xDSL (digital subscriber line). Thus, there are many authentication schemes applicable for IMS subscriber authentication, currently there are IMS-AKA (AKA: authentication and key agreement) as defined in 3GPP TS 33.203, Early IMS Security (EIS) as defined in 3GPP TS 33.978, NASS-bundled Authentication (NBA) as defined in 3GPP TS 187.003, and HTTP Digest as defined in RFC 2617 and RFC 3261.

FIG. 2 shows in a schematic manner a known authentication procedure according to an 3GPP Early IMS security (EIS) authentication framework. The course of the procedure is indicated by the numbering of the steps illustrated. Otherwise, this figure should be self-explaining for a skilled person, so a detailed description thereof is not given herein, but reference is made to 3GPP TR 33.978 for details.

Based on current specifications in 3GPP and TISPAN there are cases when the session control server S-CSCF cannot determine which authentication scheme is being requested. That makes the decision on which authentication scheme to be applied for a particular registration difficult or in certain cases impossible in the IMS network.

It is a problem of current authentication procedures and frameworks that the session control server S-CSCF is not aware of certain properties of the access network, to which the user to be authenticated is attached. However, such a lack of access network properties presently leads to a vulnerability of current authentication procedures and frameworks against various kinds of attacks.

FIG. 3 shows by way of example an attack against a 3GPP Early IMS security (EIS) authentication framework. This kind of attack is also referred to as “IP-address poisoning” attack.

In this attack representing a first use case of the present invention, an attacker makes use of the fact that a proxy server P-CSCF is attached with both a GPRS access network, which is a “trusted” network (see below), and some “not-trusted” access network. The attacker first sends a registration request with a spoofed SIP identity and a spoofed IP address (IP: Internet protocol) to a proxy server P-CSCF. The P-CSCF performs standard SIP processing of the request, including checking the “sent-by” parameter and, if required, adding “received” parameter in Via header. As the spoofed IP address was used by the UE, after this processing, those parameters will contain this spoofed IP address. Then, also as part of generic signaling procedure, the P-CSCF will forward the request toward a session control server S-CSCF (which does not have available certain security-related properties of the access network concerned) via I-CSCF. As EIS is provisioned to the victim who is identified by the spoofed SIP identity, the S-CSCF then fetches, as in normal EIS procedure, the IP address of the victim from a home subscriber server HSS/UPSF holding the respective binding with a SIP identity of the victim. As the fetched IP address is equal to the (spoofed) IP address in the “sent-by” or the “received” parameter in the Via-header of the received request, authentication of the attacker (masquerading to the victim identity) is approved by the session control server.

The basic idea behind this attack is that the EIS procedure “blindly” compares the IP address in the “sent-by” or “received” parameter in the Via-header with a reference IP address fetched from HSS/UPSF. Those parameters however are generic SIP parameters, so they will be filled in anyway regardless of the fact whether the IP address seen by the P-CSCF in the IP header of the registration request can be trusted or not, i.e. regardless of the fact whether the registration request is sent over a “trusted” or “not-trusted” access network.

As the P-CSCF is serving both “trusted” GPRS access, where EIS authentication is applicable, and “not-trusted” access, where EIS authentication is not applicable, legitimate EIS requests and malicious ones are mixed up at S-CSCF, and cannot be distinguished from each other. Thus, security cannot be provided anymore in view of an attack similar to the one described above.

A serious implication of this attack resides in that the attacker can de-register the existing registration of the victim.

As a second use case of the present invention, although not depicted, there is to be considered an authentication of SIP requests other than REGISTER requests for a Digest authentication user, i.e. a user to be authenticated by means of HTTP Digest authentication.

Typically, HTTP Digest is used as an authentication scheme for user equipment using a non-GPRS access network. A registration request is authenticated by means of Digest challenge/response. As HTTP Digest however does not provide a security association between the user equipment and a proxy server P-CSCF, non-REGISTER requests (i.e. requests other than registration requests) must also be checked and authenticated. This checking is much more simple, if the access is reliable in terms of authentication purposes, i.e. the IP address itself can be a unique identity to identify the request. In this case, it is enough to verify the IP address seen in the source IP header with one recorded during the registration. Otherwise, the non-REGISTER requests must either be authenticated with checking the preemptively sent Digest challenge in the Authorization header, or a new Digest challenge must be issued to authenticate the request. This kind of Digest re-challenging both makes the procedure much more complicated and, more even more important, increases the already high number of round trips in IMS session setup, and thus should be avoided.

However, no solution exists for either of the above-described use cases in order to provide for a reliable authentication in a communication system with a proxy server interfacing with multiple access networks.

Thus, a solution to the above-mentioned problems is needed for providing a viable and reliable authentication in a communication system supporting multiple authentication schemes.

### SUMMARY OF THE INVENTION

Consequently, it is a concern of the present invention to remove the above drawbacks inherent to the prior art and to provide accordingly improved solutions in the form of methods, network elements, apparatuses and systems.

According to a first aspect of the invention, there is provided a method of authentication. More specifically, the first aspect of the invention is directed to a method to authenticate a user of a communication system, the method comprising:

detecting, at a proxy server, an access network from the plurality of access networks, to which a user to be authenticated is attached; wherein the communication system comprises the proxy server interfacing with a plurality of access networks, a session control server, and an authenticating server;

determining, at the proxy server, a security-related attribute of the detected access network; and

notifying the determined security-related attribute from the proxy server to the session control server.

According to a second aspect of the invention, there is provided an apparatus for authentication. Specifically, the second aspect of the invention is directed to an apparatus for authenticating a user of a communication system, the apparatus comprising:

a detector configured to detect at a proxy server an access network from the plurality of access networks, to which a user to be authenticated is attached; wherein the communication system comprises the proxy server interfacing with a plurality of access networks, a session control server, and an authenticating server;

a determinator configured to determining a security-related attribute of the detected access network; and

a notifier configured to notify the determined security-related attribute from the proxy server to the session control server.

According to a third aspect of the invention, there is provided a computer program embodied in a computer-readable medium, the computer program configured to control a processor to authenticate a user of a communication system, comprising:

detecting, at a proxy server, an access network from the plurality of access networks, to which a user to be authenticated is attached; wherein the communication system comprises the proxy server interfacing with a plurality of access networks, a session control server, and an authenticating server;

determining a security-related attribute of the detected access network; and

notifying the determined security-related attribute from the proxy server to the session control server.

According to a fourth aspect of the invention, there is provided another method of authentication. Specifically, the fourth aspect of the invention is directed to a method of authentication for authenticating a user of a communication system, comprising:

receiving, at a session control server, a security-related attribute of an access network, to which a user to be authenticated is attached, from a proxy server; wherein the communication system comprises the proxy server interfacing with a plurality of access networks, the session control server, and an authenticating server;

forwarding the security-related attribute from the session control server to the authentication server;

using, at the authentication server, the forwarded security-related attribute for authentication.

According to a fifth aspect of the invention, there is provided another apparatus for authentication. Particularly, the fifth aspect of the invention is directed to an apparatus for authenticating a user of a communication system, the apparatus comprising:

a receiver configured to receive a security-related attribute of an access network, to which a user to be authenticated is attached, from the proxy server; wherein the communication system comprises the proxy server interfacing with a plurality of access networks, a session control server, and an authenticating server;

a sender configured to forward the security-related attribute from the session control server to the authentication server; and

an authenticator configured to use the security-related attribute for authentication.

According to a sixth aspect of the invention, there is provided another A computer program embodied in a computer-readable medium, the computer program configured to control a processor to authenticate a user of a communication system by performing:

receiving, at a session control server, a security-related attribute of an access network, to which a user to be authenticated is attached, from a proxy server; wherein the communication system comprises the proxy server interfacing with a plurality of access networks, the session control server, and an authenticating server;

forwarding the security-related attribute from the session control server to the authentication server;

using, at the authentication server, the forwarded security-related attribute for authentication purposes.

According to a seventh aspect of the invention, there is provided a system of authentication. More particularly, the seventh aspect of the invention is directed to a A system of authentication for authenticating a user of a communication system, said communication system comprising:

a session control server;

an authentication server; and

a proxy server interfacing with a plurality of access networks, the proxy server includes:

a detector configured to detect an access network from the plurality of access networks, to which a user to be authenticated is attached;

a determinator configured to determine a security-related attribute of the detected access network; and

a notifier configured to notify the determined security-related attribute from the proxy server to the session control server;

wherein the session control server includes:

a receiver configured to receive a security-related attribute of an access network, to which a user to be authenticated is attached, from the proxy server;

a sender configured to forward the security-related attribute from the session control server to the authentication server; and

wherein the authentication server includes: an authenticator configured to use the security-related attribute for authentication.

According to further aspects of the invention, there are provided a proxy server, a session control server and an authentication server.

Further advantageous developments and refinements of the aspects of the present invention are set out in the following.

It is to be appreciated that the features of the aspects as described may be combined in any feasible way.

### BRIEF DESCRIPTION OF THE DRAWINGS

In the following, the present invention will be described in greater detail with reference to the accompanying drawings, in which

FIG. 1 illustrates a basic overview of an IMS architecture,

FIG. 2 illustrates an authentication procedure in an 3GPP Early IMS security authentication framework,

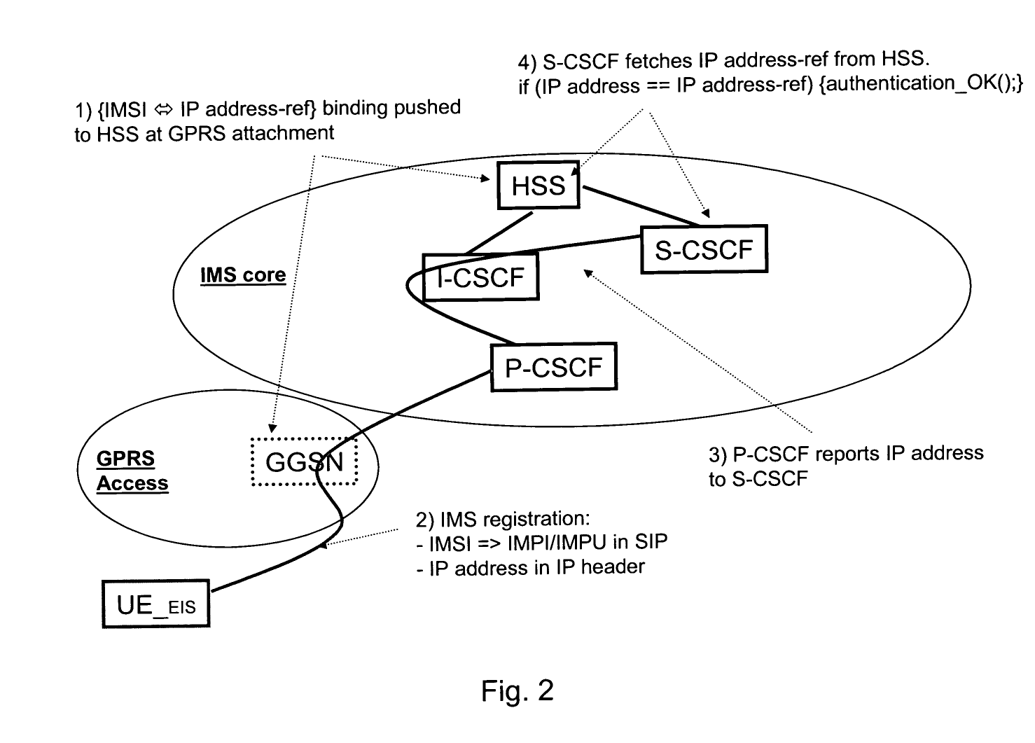

FIG. 3 illustrates an attack against an 3GPP Early IMS security authentication framework,

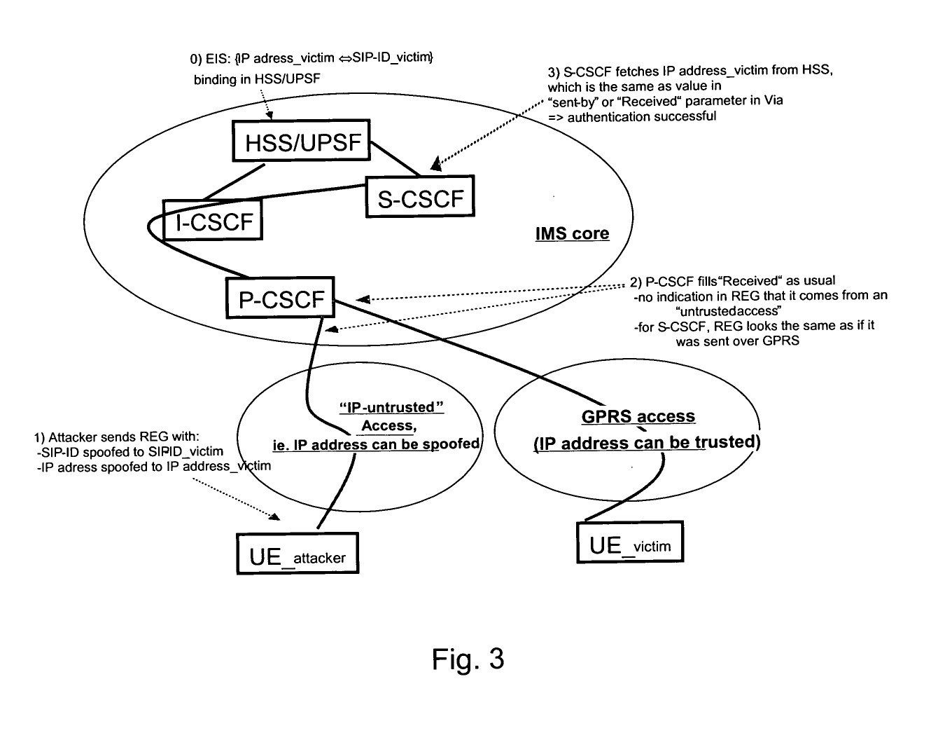

FIG. 4 illustrates a schematic presentation of access network categories,

FIG. 5 illustrates a flow chart of a method according to one embodiment of the present invention,

FIG. 6 illustrates a block diagram of a proxy server apparatus according to one embodiment of the present invention, and

FIG. 7 illustrates a block diagram of a session control server and/or authentication server apparatus according to one embodiment of the present invention.

### DETAILED DESCRIPTION OF EMBODIMENTS OF THE PRESENT INVENTION

The present invention is described herein with reference to particular non-limiting examples. A person skilled in the art will appreciate that the invention is not limited to these examples, and may be more broadly applied.

In particular, the present invention is described in relation to IMS and TIPAN networks. As such, the description of the embodiments given herein specifically refers to terminology which is directly related to IMS and TISPAN. Such terminology is only used in the context of the presented examples, and does not limit the invention in any way. For example, the use of IP addresses in the following description is to be understood as an example for any kind of network address appropriate for the respective underlying communication system scenario.

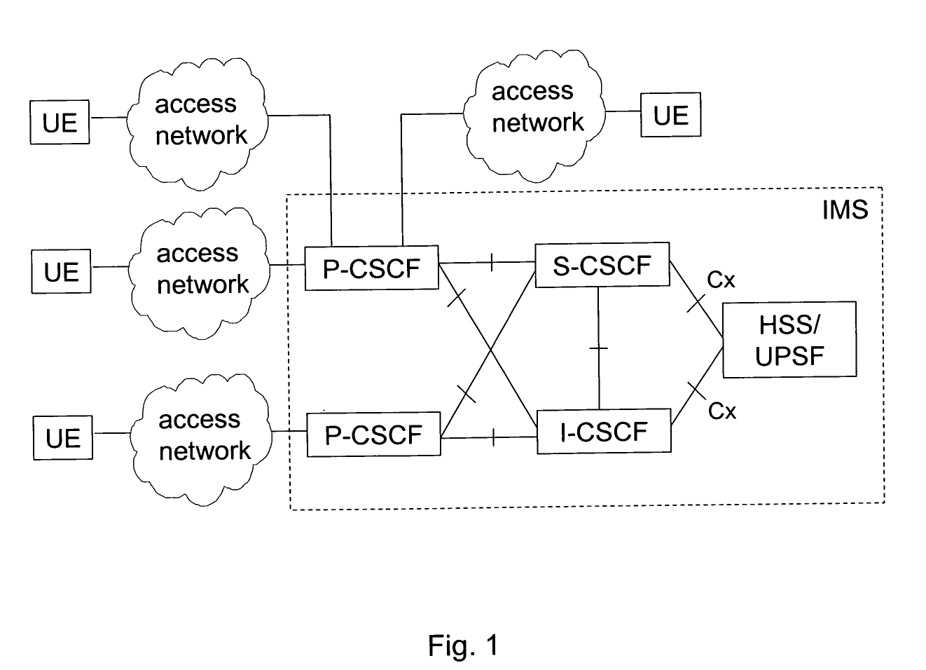

Basically, embodiments of the present invention relate to a communication system as illustrated in FIG. 1. Namely, it is assumed that a proxy server interfaces with multiple access networks, wherein these access networks are of different kinds, i.e. different technologies and/or different security standards.

For the purpose of embodiments of the present invention, security-related attributes of an access network relate for example to the following properties.

First, an access network that ensures the authenticity of a source IP address, i.e. an access network preventing IP address spoofing, is called “IP address trustable” or in short “trusted”, while the other type of access network is called “IP address non-trustable” or in short “not-trusted”.

Second, an access network, in which (related to SIP usage over this access) several users are enabled to share the same IP address, is called “IP address sharable” or in short “shared”, while the other type of access network is called “IP address non-sharable” or in short “not-shared”.

These properties are orthogonal, so combining them results in four main access (network) categories from point of view of security. The category of “trusted” and “not-shared” access networks is here also referred to as “IP-dependable”, while the remaining three categories are summarized as “IP-non-dependable” access networks.

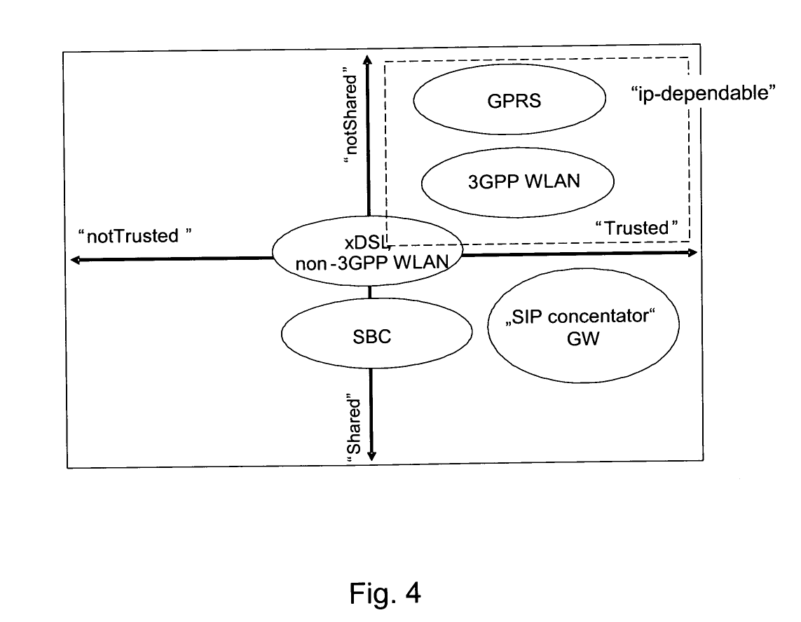

The above-described categorization is schematically illustrated in FIG. 4, also showing the categorization of some current example networks. For example, an access network like GPRS is categorized as “IP-dependable”.

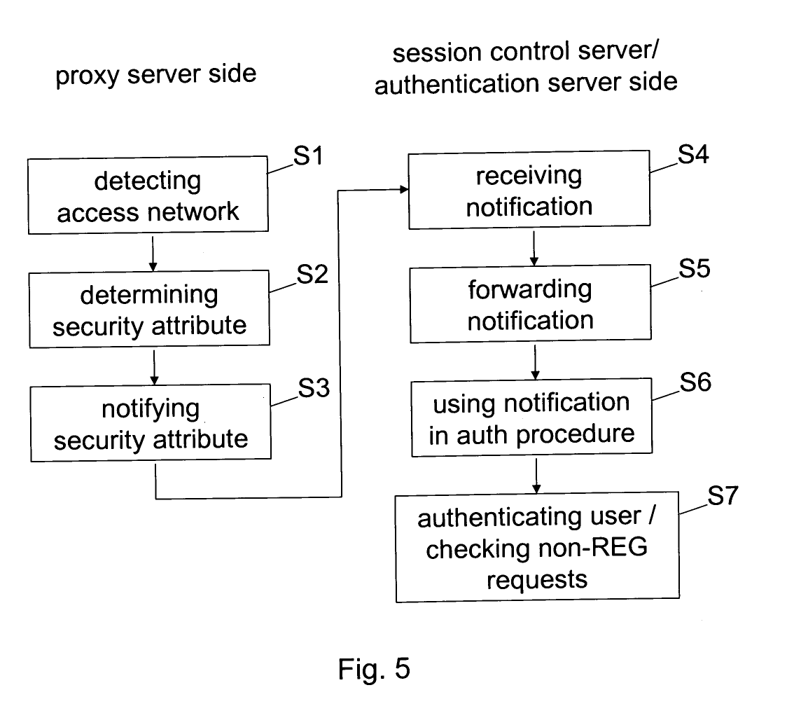

FIG. 5 illustrates a flow chart of a method according to one embodiment of the present invention. It is to be noted that, although illustrated in FIG. 1 and described in the following as one single method, further embodiments of the present invention relate to the method steps (i.e. steps S1 to S3) on the left side and to the method steps (i.e. steps S4 to S7) on the right side as separate methods.

In step S1, the proxy server interfacing with multiple access networks detects that access network, to which a user to be authenticated is attached, i.e. from which a request (e.g. SIP request) arrives at the proxy server. To this end, a proxy server according to one embodiment is configured to differentiate between the access networks connected to it. Based on the access network detected in step S1, the proxy server then determines in step S2 a security-related attribute of the detected access network (e.g. trusted, IP-dependable, etc.). Thereupon, in step S3, the proxy server notifies the determined access network attribute to a connected session control server. This attribute can be carried as an indicator on whether or not a network address (e.g. IP address) used is trusted in the requested access.

Hence, the method steps S1 through S3 are performed at a proxy server, e.g. P-CSCF.

According to one embodiment of the present invention, a detection of an access network based on network differentiation (step S1) is performed by means of a plurality of network interfaces at the proxy server, each of which is attached to and associated with a different access network. Thus, the proxy server can detect as to which access network a user concerned is attached by recognizing at which access network interface it receives a request from a respective user equipment. Each network interface is configured with corresponding attributes of its associated access network (e.g. trusted, IP-dependable, etc.).

According to one embodiment of the present invention, a determination of attributes (step S2) is performed by reading a respective attribute associated with the detected access network from a storage at the proxy server. In this case, the storage and the association between access networks and corresponding security-related attributes is to be effected in advance, either by an operator or automatically in a kind of initialization phase.

According to one embodiment of the present invention, a notification of the determined attribute from a proxy server to a session control server (step S3) is performed by carrying this access indicator (e.g. in SIP) pursuant to one of the following options.

As a first option, an extension parameter in a P-Access-Network-Info (denoted herein also as P-A-N-I) header field is used. Namely, the proxy server is thus configured to add, as an example, a parameter such as “IP=not-dependable” to the P-Access-Network-Info header to indicate that the IP address used by the user (i.e. user equipment) can not be trusted for authentication purposes, namely when a registration request has been received at the proxy server over an access network being categorized as “IP-not-dependable” (i.e. “not-trusted” and/or “shared”). At a receiving session control server, there exists a configuration parameter (list) in order to decide whether the content of the received P-Access-Network-Info is trustable or not based on the fact which proxy server has handled the request.

Carrying of the attribute indicator in the P-Access-Network-Info header is a suitable and feasible way to notify security-related attributes as this extension header has been defined for the purpose of carrying access-related information toward the core network and the further extension of the usage of this header is currently ongoing.

The use of a negative indicator is preferred in terms of backward compatibility. Namely, an “old” P-CSCF does not attach to an access network categorized as “IP-not-dependable” and has thus not to be able to send such an indicator, and a “new” P-CSCF (according to the present invention), that is attached to an access network categorized as “IP-dependable”, does not need to send it either, thus both P-CSCFs look the same in terms of functionality. The negative form (indicating that an access network is not dependable) also means that adding such negative indicator will make the authentication procedure in a S-CSCF more strict, so make it have no use for malicious usage by an attacker. It however does not mean that a “positive indicator”, i.e. indicating that an access network is “dependable”, is not applicable within present embodiments of the invention. However, using such positive form either requires that the S-CSCF must be aware of P-CSCF capability of checking P-Access-Network-Info header for example with some explicit trustable indicator or by configuration means; or if the access property is used for non-authentication purposes, for example value-added service, where the trustiness of the indication is not required.

As a second option, an extension parameter in some mandatory header field is used. That is, the determined security-related attribute is added to a header that is always created by the proxy server, such as for example a “Via” header, a “Path” header, a “P-Visited-Network-ID” header or a “P-Charging-Vector” header.

Such an extension parameter can for example be an authentication flag in the “Via” header or any other mandatory header in the registration request before sending that towards the S-CSCF. Thereby, both NBA- and EIS-related attacks can be controlled. Such an authentication flag can be configured to indicate that an NBA procedure has been performed in the proxy server (i.e. “auth=NBA”) or that the request has been received from an access network categorized as “IP-not-dependable” (i.e. “auth=not-IP-based”).

As discussed previously the use of a negative indicator here as well provides for backward compatibility as this feature only needs to be implemented if deployment cannot ensure IP address spoofing. Otherwise no indicator is used, meaning that EIS authentication is applicable.

This solution has the advantage that a session control server has explicit knowledge that the parameter has really been added by the proxy server (from which the notification is received) and not by a malicious user equipment or the like.

As a third option, a dedicated header field created by the proxy server for this purpose is used, i.e. a new header (e.g. SIP header) specifically created for this purpose.

This solution has the advantage of clarity as the new (SIP) header can have its own syntax and semantic being adapted to the demands of the specific purpose.

Referring again to FIG. 5, upon receipt of a notification from a proxy server (step S4), a session control server in step S5 forwards the notification to an authentication server. For the purpose of the present specification, the term authentication server either refers to an SIP registrar part in the S-CSCF, or to the HSS/UPSF providing authentication credentials. Hence, the authentication server in the sense of the present specification might be implemented in the same network entity as the session control server or in a separate network entity.

The authentication server uses the notification received from the session control server in the authentication procedure (step S6). The usage of the notification according to step S6 in the context of a registration procedure relates to selecting an appropriate one of the authentication schemes supported by the communication system for authenticating the user, for example to verify that the otherwise provisioned authentication scheme/s is/are really applicable considering the notified attribute of the used access network. In the context of a non-REGISTER request, such indication is used to contribute to the session control server deciding whether or not it needs to challenge this non-REGISTER request.

In step S7, dependent on the kind of usage of the notification in step S6, the user requesting authentication is actually authenticated by the authentication server using the selected appropriate authentication scheme, or non-REGISTER requests are checked/authenticated, if needed.

Hence, the method steps S4 through S7 are performed at a core network side such as for example at a session control server, e.g. S-CSCF, and/or an authentication server, e.g. S-CSCF, HSS/UPSF.

According to one embodiment of the present invention, a selection of an authentication scheme at the authentication server (step S6) is performed pursuant to the following contexts.

In case of the above-described first option of carrying a notification, NBA authentication is applicable, if NBA is provisioned e.g. in the UPSF, and the proxy server is located in the home network (of the user), and the P-Access-Network-Info is trustable and contains “dsl-location” and “network-provided” parameters.

In case of the above-described first option of carrying a notification, EIS authentication is applicable, if EIS is provisioned e.g. in the UPSF, and the proxy server is located in the home network (of the user), and there exists no P-Access-Network-Info or no IP-attribute parameter in P-Access-Network-Info; or if the P-Access-Network-Info contains the IP attribute parameter (named as “IP” parameter here) “IP=not-dependable”.

Furthermore, a parameter “IP=not-dependable” in the P-Access-Network-Info provides support for an HTTP Digest authentication procedure. That is, if no such indicator is present, it is sufficient to authenticate a registration request with HTTP Digest, and non-REGISTER requests can be checked by comparing a used IP address with IP addresses recorded at registration. If such an indicator is present, the IP address can not be used to identify the request, thus non-REGISTER requests must be authenticated using HTTP Digest as well.

As the P-Access-Network-Info is not hidden even in so-called “hiding case”, this solution is also applicable in such cases, thus outperforming the usage of e.g. a “Via” header in this aspect (pursuant to the second option mentioned above).

By virtue of the above embodiments, the S-CSCF becomes aware of a basic security-related (e.g. IP-level) attribute of the access network concerned, in particular whether or not a network address (e.g. IP address) used in the access network, to which the user is attached, is suitable for the purpose of uniquely identifying and authenticating the user equipment. This kind of indicator indicating the nature of the used network address is for example useful in the two use cases described above, as already indicated in the foregoing.

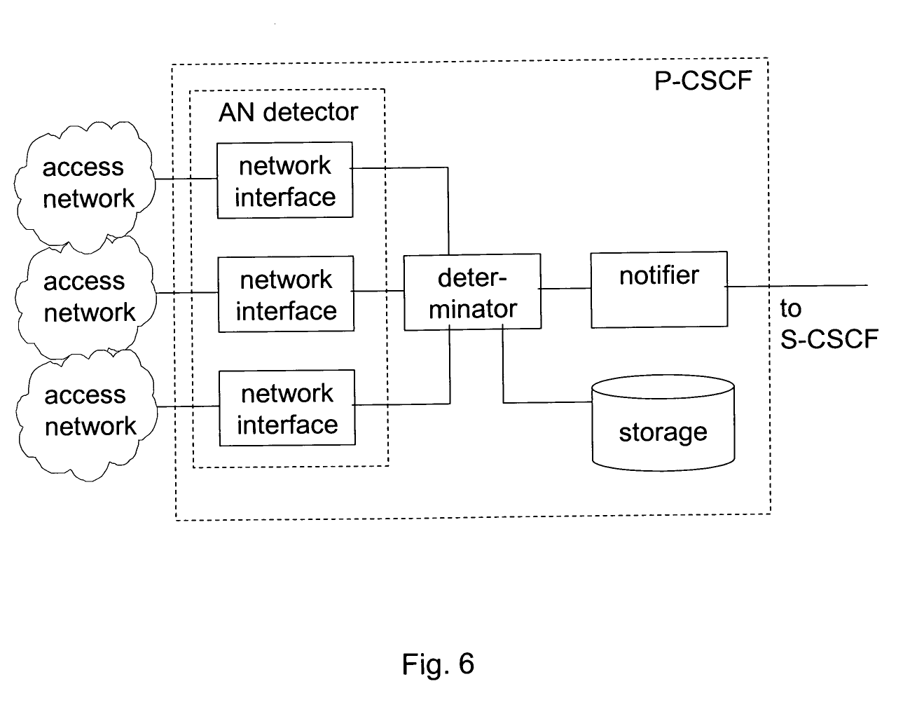

FIG. 6 illustrates a block diagram of a proxy server apparatus according to one embodiment of the present invention. It is to be noted that, although the individual blocks are depicted and described as building up a proxy server as such, one embodiment relates to these blocks building up an apparatus being arranged at a proxy server, thus potentially constituting a part or module thereof.

In FIG. 6, the proxy server denoted by P-CSCF comprises an access network (AN) detector by means of which the proxy server interfaces with multiple access networks. The AN detector, i.e. detecting means, is to detect an access network from the plurality of access networks, to which a user (i.e. a user equipment) to be authenticated (not shown) is attached. According to the embodiment depicted in FIG. 6, the AN detector comprises a plurality of network interfaces, by means of which the proxy server differentiates between the access networks. Each network interface is attached to and associated with a different access network.

The proxy server of the present embodiment further comprises a determinator, i.e. determining means, to determine a security-related attribute of the access network detected by the AN detector. Thus, the determinator is connected to each one of the network interfaces of this embodiment. In the presently depicted embodiment, the determinator is configured to read a security-related attribute associated with the detected access network from a storage of the proxy server. An association between attributes and access networks has thus to be stored in advance, e.g. by an operator or during a kind of initialization phase.

Further, the proxy server of FIG. 6 comprises a notifier connected to the determinator. The notifier represents notifying means configured to notify the determined security-related attribute from the proxy server to the session control server via an output line as indicated on the right side of FIG. 6.

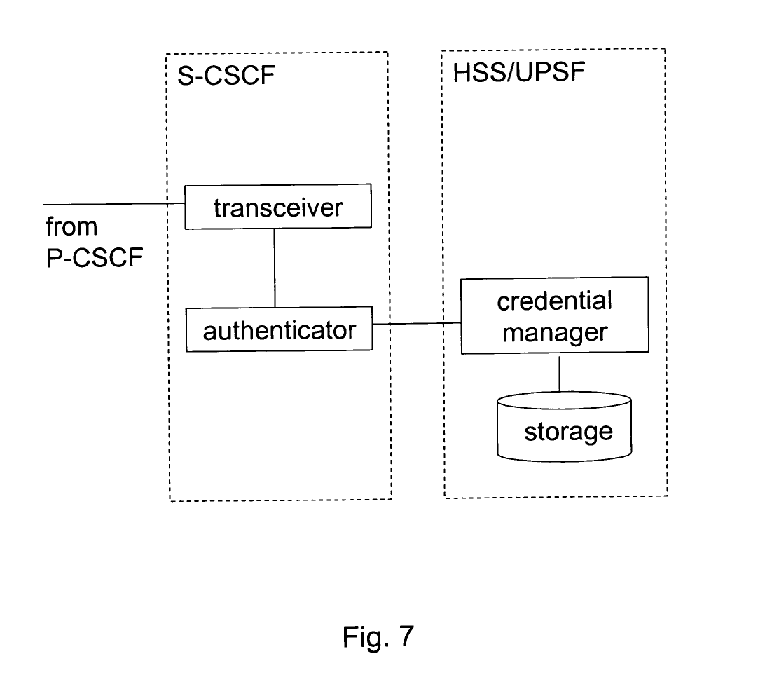

FIG. 7 illustrates a block diagram of a session control server and/or authentication server apparatus according to one embodiment of the present invention. It is to be noted that, although the individual blocks are depicted and described as building up a session control server/authentication server as such in an exemplary manner, one embodiment relates to these blocks building up an apparatus being arranged at a session control server and/or authentication server, thus potentially constituting a part or module thereof. The illustrated distribution of blocks between the individual server entities is also merely an example implementation.

In FIG. 7, the block denoted by S-CSCF is configured to play both roles, namely that of a session controller (SIP server) and that of an authentication server (SIP registrar). The actual function of the S-CSCF of FIG. 7 depends on the context of usage of the notification received from the P-CSCF (cf. steps S6 and S7 of FIG. 5). The S-CSCF of this embodiment comprises a transceiver, i.e. receiving means, to receive a notification of a security-related attribute of an access network, to which a user to be authenticated is attached, from a proxy server (e.g. P-CSCF of FIG. 6). The S-CSCF of this embodiment also comprises an authenticator, i.e. authenticating means, to perform authentication procedures including selecting a suitable authentication scheme and to execute the selected authentication scheme, and/or checking non-REGISTER requests.

Also in FIG. 7, part of an authentication server functionality is covered by the block denoted by HSS/UPSF, comprising a credential manager, i.e. managing means, to takes care of providing the S-CSCF with credentials for possible (may be more than one) authentication scheme(s) for authentication process. According to an illustrative embodiment, the credential manager is configured to use a storage of the authentication server (i.e. HSS/UPSF) for this purpose. In such a storage, an association between security properties/attributes and applicable authentication schemes is stored. In the selection, both local provisioned data and input parameters like subscriber-ID or requested authentication scheme, if detectable by the S-CSCF, are usable. Other parameters may also be involved, such as for example type of system, type of network, topology thereof, etc.

It is to be noted that FIGS. 6 and 7 only illustrate those apparatuses, parts and elements, which are directly connected with an explanation of the present invention. It is to be understood by a skilled person which and how conventional apparatuses, parts and elements are also involved in practice.

The operation of any individual element of FIGS. 6 and 7 will further be apparent to a skilled person when referring to the detailed description of the method according to FIG. 5. That is, the tangible embodiments of the present invention are configured to be operated in accordance with the method embodiments thereof. Therefore, special data structures and computer programs needed for implementing the present invention and its embodiments are also covered by the present invention.

An embodiment of the present invention relates to a system of authentication. Such a system of the present invention may comprise any conceivable combination of network entities, apparatuses and modules as described above. For example, a system of one embodiment comprises at least one P-CSCF of FIG. 6 and at least one S-CSCF as well as HSS of FIG. 7. A system of one embodiment may also comprises respective apparatuses being configured to perform any one of the methods as described above, regardless of where these apparatuses are actually arranged. A further system of one embodiment is that of FIG. 1, either including the access networks or not. In such a system the below proxy server and the I-CSCF are merely optional as they do not serve for realizing the presented functions.

Further, embodiments of the present invention include a proxy server, and/or a session control server, and/or an authentication server, a respective method of operating one of these servers, a computer program for operating one of these servers as well as a computer program for operating a system, each of which are accordingly configured with respect to the method steps set out above.

In general, it is thus to be noted that respective functional elements, e.g. detector, selector etc. according to present embodiments can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Furthermore, method steps likely to be implemented as software code portions and being run using a processor at one of the entities are software code independent and can be specified using any known or future developed programming language such as e.g. C, C++, and Assembler. Method steps and/or devices or means likely to be implemented as hardware components at one of the peer entities are hardware independent and can be implemented using any known or future developed hardware technology or any hybrids of these, such as MOS, CMOS, BiCMOS, ECL, TTL, etc, using for example ASIC components or DSP components, as an example. Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to those skilled in the art.

It is to be noted that embodiments of the present invention are particularly useful in an environment in which not all access networks are necessarily “IP-dependable”. Accordingly, embodiments of the present invention are suited to support and thus provide using access being categorized as “IP-not-dependable”, thus for example supporting multiple user equipments sharing the same IP address and/or requesting access over an access network which does not perform spoofing prevention.

Accordingly, embodiments of the present invention contribute to a determination of an applicable authentication scheme at S-CSCF, HSS or USPF, respectively, thus providing for authentication inter-working.

According to the present invention and its embodiments, there is provided an authentication of a user of a communication system comprising a proxy server interfacing with a plurality of access networks, a session control server and an authentication server, said communication system supporting at least two separate authentication schemes, comprising detecting, at the proxy server, an access network from the plurality of access networks, to which a user to be authenticated is attached; determining, at the proxy server, a security-related attribute of the detected access network; and notifying the determined security-related attribute from the proxy server to the session control server.

In view of the forgoing it becomes clear that the present invention addresses several aspects of methods, entities and elements, which are as follows:

(First Aspect)

A method of authentication for authenticating a user of a communication system comprising a proxy server interfacing with a plurality of access networks, a session control server and an authentication server, comprising:

detecting, at the proxy server, an access network from the plurality of access networks, to which a user to be authenticated is attached;

determining, at the proxy server, a security-related attribute of the detected access network; and

notifying the determined security-related attribute from the proxy server to the session control server.

The above method, wherein detecting access network comprises differentiating between access networks by means of a plurality of network interfaces, each of which is associated with an access network.

The above method, wherein determining a security-related attribute comprises reading a security-related attribute associated with the detected access network from a storage.

The above method, wherein the security-related attribute pertains to a network address used in the detected access network by a user to be authenticated.

The above method, wherein the security-related attribute indicates, whether a network address used in the detected access network by a user to be authenticated is dependable for authentication.

The above method, wherein a network address used in the detected access network by a user to be authenticated is a network address according to an Internet protocol.

The above method, wherein notifying the determined attribute comprises, as a first option, using an extension parameter in an access network information header field.

The above method, wherein notifying the determined attribute comprises, as a second option, using an extension parameter in a mandatory header field.

The above method, wherein notifying the determined attribute comprises, as a third option, using a dedicated header field created by the proxy server for this purpose.

The above method, wherein the proxy server comprises a proxy call session control function, P-CSCF.

The above method, wherein the session control server and/or the authentication server comprises a serving call session control function, S-CSCF.

(Second Aspect)

An apparatus, usable for authenticating a user of a communication system comprising a proxy server interfacing with a plurality of access networks, a session control server and an authentication server, the apparatus comprising:

a detector configured to detect an access network from the plurality of access networks, to which a user to be authenticated is attached;

a determinator configured to determine a security-related attribute of the detected access network; and

a notifier configured to notify the determined security-related attribute from the proxy server to the session control server.

The above apparatus, said detector comprising a plurality of network interfaces, each of which is associated with an access network, configured to differentiate between access networks.

The above apparatus, said determinator comprising a reader configured to read a security-related attribute associated with the detected access network from a storage.

The above apparatus, wherein the security-related attribute pertains to a network address used in the detected access network by a user to be authenticated.

The above apparatus, wherein the security-related attribute indicates, whether a network address used in the detected access network by a user to be authenticated is dependable for authentication.

The above apparatus, wherein a network address used in the detected access network by a user to be authenticated is a network address according to an Internet protocol.

The above apparatus, said notifier being configured to notify the determined attribute, as a first option, by using an extension parameter in an access network information header field, like for example “P-Access-Network-Info” extension SIP header.

The above apparatus, said notifier being configured to notify the determined attribute, as a second option, by using an extension parameter in a mandatory header field, like for example “Via”, “Path”, “P-Visited-Network-ID” or “P-Charging-Vector” SIP headers.

The above apparatus, said notifier being configured to notify the determined attribute, as a third option, by using a dedicated header field created by the proxy server for this purpose.

The above apparatus, said apparatus being arranged at the proxy server.

The above apparatus, said apparatus being further configured to operate as the proxy server.

(Third Aspect)

A computer program embodied in a computer-readable medium comprising program code configured to operate an apparatus for authenticating a user of a communication system comprising a proxy server interfacing with a plurality of access networks, a session control server and an authentication server, the computer program being configured to perform:

detecting an access network from the plurality of access networks, to which a user to be authenticated is attached;

determining a security-related attribute of the detected access network; and

notifying the determined security-related attribute from the proxy server to the session control server.

The computer program, said computer program being embodied at the proxy server.

(Fourth Aspect)

A method of authentication for authenticating a user of a communication system comprising a proxy server interfacing with a plurality of access networks, a session control server and an authentication server, comprising:

receiving, at the session control server, a security-related attribute of an access network, to which a user to be authenticated is attached, from the proxy server;

forwarding the security-related attribute from the session control server to the authentication server;

using, at the authentication server, the forwarded security-related attribute for authentication purposes.

The above method, wherein the security-related attribute pertains to a network address used in the detected access network by a user to be authenticated.

The above method, wherein the security-related attribute indicates, whether a network address used in the detected access network by a user to be authenticated is dependable for authentication.

The above method, wherein a network address used in the detected access network by a user to be authenticated is a network address according to an Internet protocol.

The above method, the using of the security-related attribute comprising as a first alternative:

selecting an appropriate one of authentication schemes supported by the communication system for authenticating the user based on the determined security-related attribute; and

authenticating the user, by the authentication server, based on the selected appropriate authentication scheme.

The above method, the using of the security-related attribute comprising as a second alternative:

selecting a suitable procedure of checking non-registration requests; and

performing checking or authentication of non-registration requests based on the selected suitable checking procedure.

The above method, wherein the proxy server comprises a proxy call session control function, P-CSCF.

The above method, wherein the session control server and/or the authentication server comprises a serving call session control function, S-CSCF.

(Fifth Aspect)

An apparatus, usable for authenticating a user of a communication system comprising a proxy server interfacing with a plurality of access networks, a session control server and an authentication server, the apparatus comprising:

a receiver configured to receive a security-related attribute of an access network, to which a user to be authenticated is attached, from the proxy server;

a sender configured to forward the security-related attribute from the session control server to the authentication server;

an authenticator configured to use the security-related attribute for authentication purposes.

The above apparatus, wherein the security-related attribute pertains to a network address used in the detected access network by a user to be authenticated.

The above apparatus, wherein the security-related attribute indicates, whether a network address used in the detected access network by a user to be authenticated is dependable for authentication.

The above apparatus, wherein a network address used in the detected access network by a user to be authenticated is a network address according to an Internet protocol.

The above apparatus according to a first alternative, the authenticator being further configured to select an appropriate one of authentication schemes supported by the communication system for authenticating the user based on the security-related attribute;

the apparatus further comprising:

a credential manager configured to provide a credential for one or more supported authentication schemes for authenticating the user based on the selected appropriate authentication scheme.

The above apparatus according to a second alternative, the authenticator being further configured to:

select a suitable procedure of checking non-registration requests; and

perform checking or authentication of non-registration requests based on the selected suitable checking procedure.

The above apparatus, said apparatus being arranged at the session control server and/or the authentication server.

The above apparatus, said apparatus being further configured to operate as the session control server and/or the authentication server.

(Sixth Aspect)

A computer program embodied in a computer-readable medium comprising program code configured to operate an apparatus for authenticating a user of a communication system comprising a proxy server interfacing with a plurality of access networks, a session control server and an authentication server, the computer program being configured to perform:

receiving, at the session control server, a security-related attribute of an access network, to which a user to be authenticated is attached, from the proxy server;

forwarding the security-related attribute from the session control server to the authentication server;

using, at the authentication server, the forwarded security-related attribute for authentication purposes.

The above computer program, being further configured such that the using of the security-related attribute comprises as a first alternative:

selecting an appropriate one of authentication schemes supported by the communication system for authenticating the user based on the determined security-related attribute; and

authenticating the user, by the authentication server, based on the selected appropriate authentication scheme.

The above computer program, being further configured such that the using of the security-related attribute comprises as a second alternative:

selecting a suitable procedure of checking non-registration requests; and

performing checking or authentication of non-registration requests based on the selected suitable checking procedure.

The computer program, said computer program being embodied at the session control server and/or the authentication server.

(Seventh Aspect)

A system of authentication for authenticating a user of a communication system comprising a proxy server interfacing with a plurality of access networks, a session control server and an authentication server, said communication system, comprising:

at least one apparatus of the second aspect; and

at least one apparatus of the fifth aspect.

The above system, being configured to operate according to the method of the first aspect and/or the method of the fourth aspect.

(Further Aspects)

A proxy server or module thereof, comprising an apparatus of the second aspect.

The above proxy server, being configured to operate according to a method of the first aspect.

A session control server or module thereof, comprising an apparatus of the fifth aspect.

The above session control server, being configured to operate according to a method of the fourth aspect.

An authentication server or module thereof, comprising an apparatus of the fifth aspect.

The authentication server, being configured to operate according to method of the fifth aspect.

Even though the invention is described above with reference to the examples according to the accompanying drawings, it is clear that the invention is not restricted thereto. Rather, it is apparent to those skilled in the art that the present invention can be modified in many ways without departing from the scope of the inventive idea as disclosed herein.

What is claimed:

1. A method for authenticating a user of a communication system, the method comprising:
detecting, at a proxy server, an access network from the plurality of access networks, to which a user to be authenticated is attached, wherein the communication system comprises the proxy server interfacing with a plurality of access networks, a session control server, and an authenticating server;
determining, at the proxy server, a security-related attribute of the detected access network; and
notifying the determined security-related attribute from the proxy server to the session control server.

2. The method of claim 1, wherein the detecting of the access network comprises differentiating between a plurality of network interfaces from the access networks.

3. The method of claim 1, wherein the determining of the security-related attribute comprises reading a security-related attribute associated with the detected access network from a storage.

4. The method of claim 1, the security-related attribute including a network address used in the detected access network by a user to be authenticated.

5. The method of claim 1, the security-related attribute indicating whether a network address used in the detected access network by a user to be authenticated is dependable for authentication.

6. The method of claim 1, further comprising: using a network address according to an internet protocol in the detected access network by a user to be authenticated.

7. The method of claim 1, wherein the notifying of the determined attribute comprises using an extension parameter in an access network information header field.

8. The method of claim 1, wherein the notifying of the determined attribute comprises using an extension parameter in a mandatory header field.

9. The method of claim 1, wherein the notifying of the determined attribute comprises using a dedicated header field created by the proxy server.

10. The method of claim 1, wherein the proxy server comprises a proxy call session control function.

11. The method of claim 1, wherein the session control server and/or the authentication server comprises a serving call session control function.

12. An apparatus for authenticating a user of a communication system, the apparatus comprising:
a detector configured to detect, at a proxy server, an access network from the plurality of access networks, to which a user to be authenticated is attached, wherein the communication system comprises the proxy server interfacing with a plurality of access networks, a session control server, and an authenticating server;
a determinator configured to determine, at the proxy server, a security-related attribute of the detected access network; and
a notifier configured to notify the determined security-related attribute from the proxy server to the session control server.

13. The apparatus of claim 12, wherein said detector comprises a plurality of network interfaces, each of which is associated with an access network, said detector configured to differentiate between access networks.

14. The apparatus of claim 12, wherein said determinator comprising a reader is configured to read a security-related attribute associated with the detected access network from a storage.

15. The apparatus of claim 12, wherein the security-related attribute includes a network address used in the detected access network by a user to be authenticated.

16. The apparatus of claim 12, wherein the security-related attribute indicates whether a network address used in the detected access network by a user to be authenticated is dependable for authentication.

17. The apparatus of claim 12, wherein a network address used in the detected access network by a user to be authenticated is a network address according to an internet protocol.

18. The apparatus of claim 12, wherein said notifier is configured to notify the determined attribute by using an extension parameter in an access network information header field.

19. The apparatus of claim 12, wherein said notifier is configured to notify the determined attribute by using an extension parameter in a mandatory header field.

20. The apparatus of claim 12, wherein said notifier is configured to notify the determined attribute by using a dedicated header field created by the proxy server.

21. A computer program embodied in a computer-readable medium, the computer program configured to control a processor to authenticate a user of a communication system, comprising:
detecting an access network from the plurality of access networks, to which a user to be authenticated is attached, wherein the communication system comprises the proxy server interfacing with a plurality of access networks, a session control server, and an authenticating server;
determining a security-related attribute of the detected access network; and
notifying the determined security-related attribute to the session control server.

22. The computer program of claim 21, said computer program being configured to be executed at the proxy server.

23. An apparatus for authenticating a user of a communication system, the apparatus comprising:
a receiver configured to receive, at a session control server, a security-related attribute of an access network, to which a user to be authenticated is attached, from the proxy server, wherein the communication system comprises the proxy server interfacing with a plurality of access networks, a session control server, and an authenticating server;
a sender configured to forward the security-related attribute from the session control server to the authentication server; and
an authenticator configured to use the security-related attribute for authentication.

24. The apparatus of claim 23, wherein the security-related attribute includes a network address used in the detected access network by a user to be authenticated.

25. The apparatus of claim 23, wherein the security-related attribute indicates whether a network address used in the detected access network by a user to be authenticated is dependable for authentication.

26. The apparatus of claim 23, wherein a network address used in the detected access network by a user to be authenticated is a network address according to an internet protocol.

27. The apparatus of claim 23, wherein the authenticator is further configured to select an appropriate one of authentication schemes supported by the communication system for authenticating the user based on the security-related attribute; and
the apparatus further comprises:
a credential manager configured to provide a credential for one or more supported authentication schemes for authenticating the user based on the selected appropriate authentication scheme.

28. The apparatus of claim 23, wherein the authenticator is further configured to
select a suitable procedure of checking non-registration requests; and
perform checking or authentication of non-registration requests based on the selected suitable checking procedure.

29. The apparatus of claim 23, wherein said apparatus is at the session control server and/or the authentication server.

30. The apparatus of claim 23, wherein said apparatus being further configured to operate as the session control server and/or the authentication server.

31. A computer program embodied in a computer-readable medium, the computer program configured to control a processor to authenticate a user of a communication system by performing:
receiving, at a session control server, a security-related attribute of an access network, to which a user to be authenticated is attached, from a proxy server, wherein the communication system comprises the proxy server interfacing with a plurality of access networks, the session control server, and an authenticating server;
forwarding the security-related attribute from the session control server to the authentication server;
using, at the authentication server, the forwarded security-related attribute for authentication purposes.

32. The computer program of claim 31, further configured to perform:
selecting an appropriate one of authentication schemes supported by the communication system for authenticating the user based on the determined security-related attribute; and
authenticating the user, by the authentication server, based on the selected appropriate authentication scheme.

33. The computer program of claim 31, further configured to perform:
selecting a suitable procedure of checking non-registration requests; and
performing checking or authentication of non-registration requests based on the selected suitable checking procedure.

34. The computer program of claim 31, wherein said computer program is embodied at the session control server and/or the authentication server.

35. A system of authentication for authenticating a user of a communication system, said communication system comprising:
a session control server;
an authentication server; and
a proxy server interfacing with a plurality of access networks,
wherein the proxy server includes:
a detector configured to detect an access network from the plurality of access networks, to which a user to be authenticated is attached;
a determinator configured to determine a security-related attribute of the detected access network; and
a notifier configured to notify the determined security-related attribute from the proxy server to the session control server;
wherein the session control server includes:
a receiver configured to receive a security-related attribute of an access network, to which a user to be authenticated is attached, from the proxy server;
a sender configured to forward the security-related attribute from the session control server to the authentication server; and
wherein the authentication server includes: an authenticator configured to use the security-related attribute for authentication.

36. An apparatus for authenticating a user of a communication system, the apparatus comprising:
detector means, at a proxy server, for detecting an access network from the plurality of access networks, to which a user to be authenticated is attached, wherein the communication system comprises the proxy server interfacing with a plurality of access networks, a session control server, and an authenticating server;
determinator means for determining, at the proxy server, a security-related attribute of the detected access network; and
notifier means for notifying the determined security-related attribute from the proxy server to the session control server.

37. An apparatus for authenticating a user of a communication system, the apparatus comprising:
receiver means, at a session control server, for receiving a security-related attribute of an access network, to which a user to be authenticated is attached, from a proxy server, wherein the communication system comprises the proxy server interfacing with a plurality of access networks, the session control server, and an authenticating server;
sender means for forwarding the security-related attribute from the session control server to the authentication server; and
authenticator means for using the security-related attribute for authentication.
